(19) United States
(12) Patent Application Publication
(10) Pub. No.: US 2014/0117128 A1
(43) Pub. Date: May 1, 2014

(54) EQUIPMENT TO PREPARE ORE CONCENTRATE FOR PELLETIZING

(71) Applicant: Marko Palander, Inkoo (FI)

(72) Inventor: Marko Palander, Inkoo (FI)

(73) Assignee: OUTOTEC OYJ, Espoo (FI)

(21) Appl. No.: 14/126,369

(22) PCT Filed: Jun. 13, 2012
(86) PCT No.: PCT/FI2012/050595

§ 371 Date: Dec. 13, 2013

(30) Foreign Application Priority Data
Jun. 15, 2011 (FI) U20114064

(51) Int. Cl. B02C 23/24; F26B 23/02

(52) U.S. Cl. CPC B02C 23/24; F26B 23/02
USPC 241/65

(57) ABSTRACT

The invention relates to an equipment to prepare ore concentrate for pelletizing and sintering/indurating of pellets in ferroalloys production. The equipment comprises a grinder (1) arranged to grind the concentrate to a predetermined grain size. The equipment further comprises a drying apparatus (2, 3, 4) arranged to dry the concentrate before and/or during grinding by the grinder (1).

The invention relates to an equipment to prepare ore concentrate for pelletizing and sintering/indurating of pellets in connection with ferroalloys production.

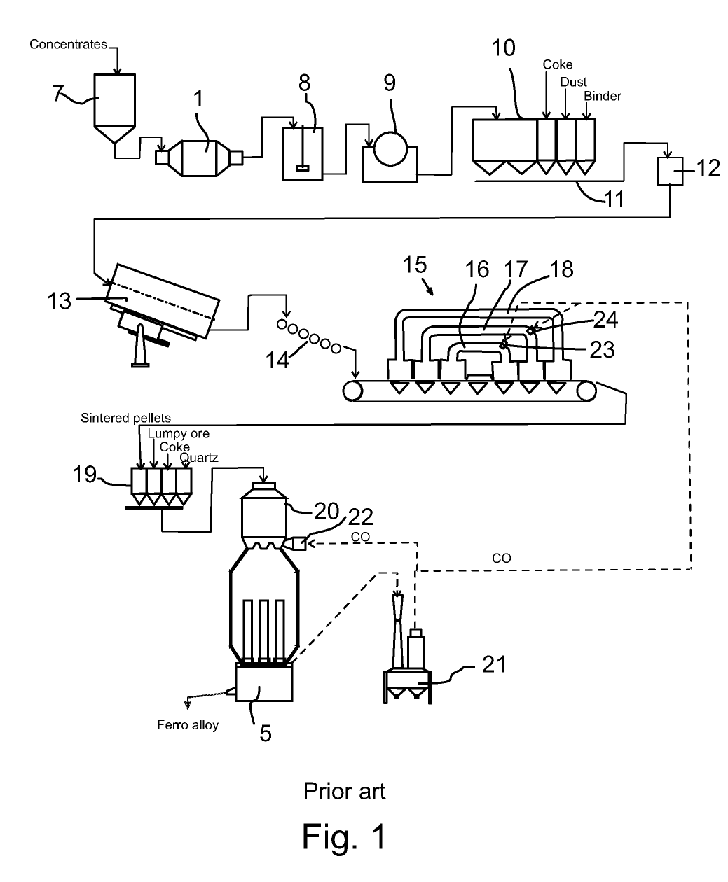

A prior art process and equipment for the production of ferroalloys is schematically shown in FIG. 1. For example, the shown prior art process may relate to the production of ferrochrome from chromite concentrates but it can also be applied to the production of other ferroalloys.

The raw material is obtained from a mine. The ore concentrate is stored and initially fed to the process from a day bin 7. Typically the ore concentrate has moisture content more than 1%. The equipment further comprises a grinder 1 for grinding the coarse ore concentrate to a predetermined grain size which is suitable for the subsequent pelletizing step.

In prior art the grinder 1 is a wet grinder, such as a ball mill, whereto the material to be ground is fed together with the addition of water. A ball mill 1 is a rotating drum which is partially filled with the material to be ground and grinding medium. Different materials are used as grinding media, including ceramic balls, flint pebbles and steel balls. As the drum rotates the grinding media rise with the aid of centrifugal force along with the inner surface of the drum and eventually fall on the material to be ground. Various factors, like the size of the grinding media and the rotation speed of the drum, affect to the degree of grinding.

The wet grinder 1 is followed by a slurry mixer 8 which is arranged to mix the slurry discharged from the wet grinder 1.

The slurry mixed in the slurry mixer is then led to filter 9, which can be a capillary-effect ceramic disc filter. The filter 9 is arranged to dewater the concentrate slurry by filtering to form a dewatered mineral concentrate.

From the filter 9 the concentrate is conveyed to intermediate bins 10. Also other additives, solid fuel (coke fine which acts as a fuel in the subsequent sintering/indurating process), process dust and binding agent (bentonite clay) are conveyed to first intermediate bins 10.

The concentrate and the additives are distributed from the intermediate bins 10 onto a conveyor 11 which conveys these materials to a mixer 12.

The mixer 12 is arranged to mix the concentrate with solid fuel, process dust and binder to form a homogenous mixture of these. Also an amount of water can be added into the mixer 12 to ensure that the mixture has sufficient moisture content for pelletizing.

Further, the equipment comprises a pelletizing drum or disc 13 which is arranged to pelletize the mixture obtained from the mixer 12 to green pellets.

Further, the process equipment includes a roller screen 14 to ensure that uniformly sized green pellets only are fed as an even pellet bed to the endless conveyor belt of the strand sintering/indurating furnace 15.

In the continuously working strand sintering/indurating furnace 15 the pellet bed is exposed to subsequent drying, heating, sintering/firing and cooling steps, each of them having different temperature conditions, as the pellet bed is conveyed through respective zones of the furnace 15. The sintering/indurating furnace includes circulation gas ducts 16, 17, 18 which circulate gas from the cooling zones to the drying, heating and sintering/firing zones for the purpose of saving energy. After the sintering/indurating the pellets are spherical, uniformly sized, hard and porous with consistent physical and chemical properties. They are ideal charging material for ferroalloy smelting in the smelting furnace 5.

From the strand sintering/indurating furnace 15 the pellets are conveyed to second intermediate bins 19. Reference number 19 also refers to bins for additives, like lumpy ore, coke, and quartz sand which together with pellets are charged to a preheating kiln 20.

The preheating kiln 20 is arranged to preheat the pellets before charging to the smelting furnace 5. The smelting furnace 5 is an electric arc furnace. In the smelting furnace 5 the pellets are smelted and reduced to ferroalloy. The molten ferroalloy discharged from the smelting furnace 5 is casted to ferroalloy products suitable for further production of metal.

The carbon monoxide rich off-gas exiting from the smelting furnace 5 is cleaned in a gas scrubber 21. The cleaned CO gas is used as a fuel which is burned by a burner 22 in the preheating kiln 20 to produce the sufficient heating energy for preheating of the pellets. The cleaned CO gas is also led to burners 23 and 24 located in the walls of the gas circulating ducts 16 and 17 of the strand sintering/indurating furnace 15 to heat the gas flowing in the ducts.

The problem of the prior art equipment and process relates to an ever decreasing availability of good quality raw materials. More often the raw material to be processed has a very poor quality because it contains or forms very fine fractions, e.g. clay-like chromite. “Fine fractions” stands typically for that 80% of particles have a size less than 75 μm. Wet filtering of the fine fractions in order to dewater those is difficult since fine fractions tend to clog the filters. Also the time required to dewater the material with a ceramic filter is too long for the process and requires a series of filters whereby the required investment becomes vast.

It is an object of the invention to overcome the disadvantages of the prior art as outlined above.

According to the invention the equipment comprises a drying apparatus arranged to dry the concentrate before and/or during grinding by the grinder.

The invention provides many advantages. By the arrangement of a drying apparatus to dry the concentrate before and/or during grinding by the grinder it is achieved that the concentrate can be dry ground and no subsequent dewatering by filters is needed. With the aid of the invention it is possible to cost-effectively utilize raw materials containing fine fractions which normally would be difficult to dewater by filtering.

In one embodiment, the drying apparatus is arranged to dry ore concentrate by the heat energy obtained from burning carbon monoxide.

In one embodiment, the drying apparatus is arranged to dry ore concentrate by the heat energy obtained from burning carbon monoxide rich off-gas from a smelting furnace. By utilizing the CO gas from the smelting furnace to produce the sufficient heat energy for drying is advantageous because fossil fuels are thus not needed.

In one embodiment, the drying apparatus comprises a burning chamber comprising a burner arranged to burn carbon monoxide and/or carbon monoxide rich off-gas to produce hot gases, and a drying chamber arranged to dry ore concentrate with said hot gases.

In one embodiment, the grinder comprises a grinding chamber arranged to grind the ore concentrate during conveyance the ore concentrate through the grinding chamber. The grinding chamber and the drying chamber are built together, so that hot gases from a separate burning chamber are led to the grinding chamber.

In one embodiment, the burning chamber, the drying chamber and the grinding chamber are built together so that the burner producing hot gases is attached directly to the grinder.

The accompanying drawings, which are included to provide a better understanding of the invention constitute part of the description, illustrate preferred embodiments of the invention and help to explain the principles of the invention.

FIG. 1 shows a schematic flow chart of a prior art ferroalloys process and process equipment,

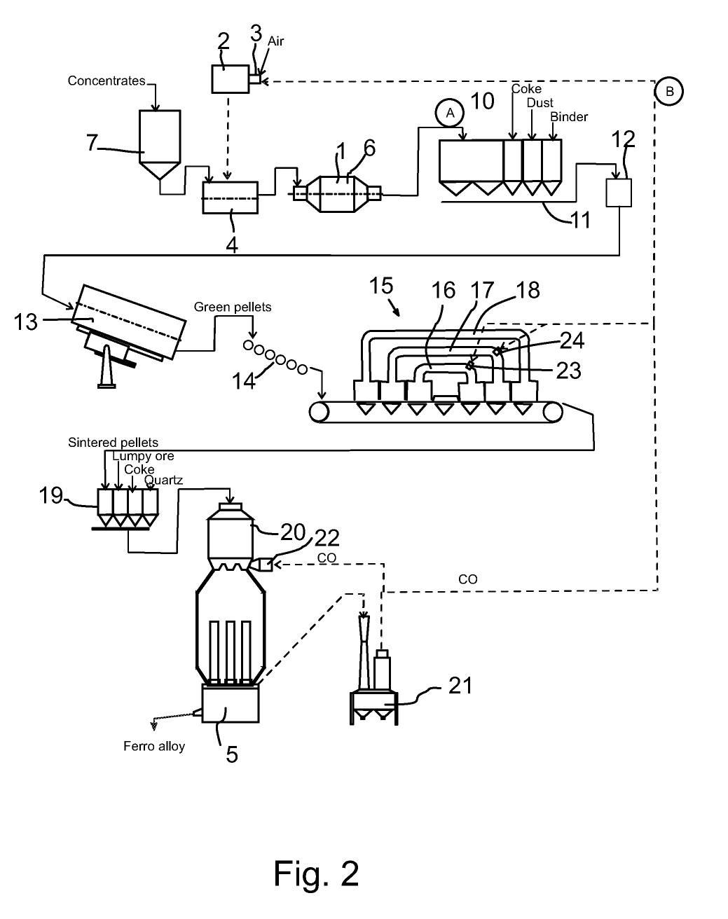

FIG. 2 shows a schematic flow chart of a ferroalloys process and process equipment of a first embodiment of the invention,

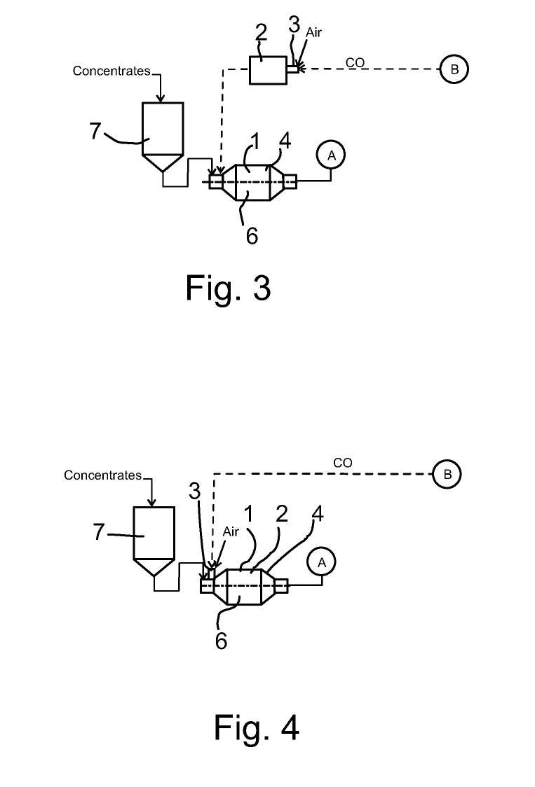

FIG. 3 shows the beginning of the ferroalloys process and process equipment of a second embodiment of the invention, and

FIG. 4 shows the beginning of the ferroalloys process and process equipment of a third embodiment of the invention.

Referring to FIG. 2, the raw material is obtained from a mine. The raw material, ore concentrate, is stored and initially fed to the process from a day bin 7. Typically the ore concentrate has moisture content more than 1%.

Equipment of the FIG. 2 comprises a grinder 1 for grinding the coarse ore concentrate to a predetermined grain size which is suitable for the subsequent pelletizing step. In contrast to the prior art equipment the grinder 1 in the invention is dry grinder 1. In order to dry the ore concentrate before it is fed to the grinder 1 it must be dried. For that purpose the equipment comprises a drying apparatus into which the ore concentrate is fed from the day bin 7.

The drying apparatus comprises a burning chamber 2 comprising a burner 3. The burner 3 is arranged to burn carbon monoxide and/or cleaned carbon monoxide rich off-gas obtained from the smelting furnace 5 with air to produce hot gases. The temperature of the cleaned CO gas is about 30° C. to 60° C. The resulting gas after burning comprises water, nitrogen, carbon monoxide and some oxygen. The temperature of these hot drying gases is about 300° C. to 500° C.

The hot gases are led to a drying chamber 4 which is arranged to dry ore concentrate with said hot gases.

In FIG. 2 the burning chamber 2 and the drying chamber 4 are separate units. The drying chamber 4 may be a rotating drum which while it rotates conveys the material to be dried from the charge end to the discharge end.

The dried ore concentrate is fed to the dry grinder 1. The grinder 1 comprises a grinding chamber 6 arranged to grind the ore concentrate during conveyance the ore concentrate through the grinding chamber. The dry grinder 1 may be a ball mill. A ball mill 1 is a rotating drum which is partially filled with the material to be ground and grinding medium. Different materials are used as grinding media, including ceramic balls, flint pebbles and steel balls. As the drum rotates the grinding media rise with the aid of centrifugal force along with the inner surface of the drum and eventually fall on the material to be ground. Various factors, like the size of the grinding media and the rotation speed of the drum, affect to the degree of grinding. The temperature of the ore concentrate discharged from the dry grinder 1 is less than 100° C.

After the dry grinder 1 at point A inside a circle the process may continue in a manner as depicted in FIG. 1. From the dry grinder 1 the concentrate is conveyed to intermediate bins 10. Since the concentrate is dry, it does not have to be dewatered by any filters like in the prior art process of FIG. 1.

Also other additives, solid fuel (coke fine which acts as a fuel in the subsequent sintering/indurating process), process dust and binding agent (bentonite clay) are conveyed to the intermediate bins 10.

The concentrate and the additives are distributed from the intermediate bins 10 onto a conveyor 11 which conveys these materials to a mixer 12.

The mixer 12 is arranged to mix the concentrate with solid fuel, process dust and binder to form a homogenous mixture of these. Also an amount of water can be added into the mixer 12 to ensure that the mixture has sufficient moisture content for pelletizing.

Further, the equipment comprises a pelletizing drum 13 which is arranged to pelletize the mixture obtained from the mixer 12 to green pellets. Green pellets have a sufficient cohesiveness so that they can be conveyed and screened without breakage.

Further, the process equipment includes a roller screen 14 to ensure that uniformly sized green pellets only are fed as an even pellet bed to the endless conveyor belt of the strand sintering/indurating furnace 15.

In the continuously working strand sintering/indurating furnace 15 the pellet bed is exposed to subsequent drying, heating, sintering/firing and cooling steps, each of them having different temperature conditions, as the pellet bed is conveyed through respective zones of the furnace 15. The sintering/indurating furnace includes circulation gas ducts 16, 17, 18 which circulate gas from the cooling zones to the drying, heating and sintering/firing zones for the purpose of saving energy. After the sintering/indurating the pellets are spherical, uniformly sized, hard and porous with consistent physical and chemical properties. They are ideal charging material for ferroalloy smelting in the smelting furnace 5.

From the strand sintering/indurating furnace 15 the pellets are conveyed to a second intermediate bin 19. Reference number 19 also refers to bins for additives, like lumpy ore, coke, and quartz sand. The sintered/indurated pellets and additives are charged to a preheating kiln 20.

The preheating kiln 20 is arranged to preheat the pellets before charging to the smelting furnace 5. The smelting furnace 5 is a closed-type electric arc furnace. In the smelting furnace 5 the pellets are smelted and reduced to ferroalloy. The molten ferroalloy discharged from the smelting furnace 5 is casted to ferroalloy products suitable for further production of metal.

The carbon monoxide rich off-gas exiting from the smelting furnace 5 is cleaned in a gas scrubber 21. The gas scrubber 21 may be an ejector venturi scrubber operating by wet cleaning principle.

The cleaned CO gas is used as a fuel which is burned by a burner 22 in the preheating kiln 20 to produce the sufficient heating energy for preheating of the pellets. The cleaned CO gas is also led to burners 23 and 24 located in the walls of the gas circulating ducts 16 and 17 of the strand sintering/indurating furnace 15 to heat the gas flowing in the ducts. The CO gas pipeline is indicated in FIG. 2 with the reference marking B inside a circle.

In FIG. 3 there is shown a modification of the equipment of FIG. 2. In this embodiment the grinding chamber 6 and the drying chamber 4 are built together. The hot gases from a separate burning chamber 2 are led to the grinding chamber 6 which also acts as a drying chamber 4. The burning chamber 2 is separate from the combined grinding and drying chamber 4, 6. Otherwise, the equipment and process may be similar to the one depicted in FIG. 2. The process may hereafter continue as indicated by the marking A inside a circle in FIG. 2. The CO gas pipeline as indicated with the reference marking B inside a circle may be similar to that shown in FIG. 2.

In FIG. 4 there is shown a further modification of the equipment of FIG. 2. In this embodiment the burning chamber 2, the drying chamber 4 and the grinding chamber 6 are all built together. The burner 3 is attached directly to the grinder 1. The process may hereafter continue as indicated by the marking A inside a circle in FIG. 2. The CO gas pipeline as indicated with the reference marking B inside a circle may be similar to that shown in FIG. 2.

It is obvious to a person skilled in the art that with the advancement of technology, the basic idea of the invention may be implemented in various ways. The invention and its embodiments are thus not limited to the examples described above; instead they may vary within the scope of the claims.

1. A device to prepare ore concentrate for pelletizing and sintering/indurating of pellets in ferroalloys production, the device comprising a grinder arranged to grind the concentrate to a predetermined grain size, and a drying apparatus arranged to dry the concentrate at least one of before and during grinding by the grinder.

2. The device according to claim 1, where the drying apparatus is arranged to dry ore concentrate by the heat energy obtained from burning carbon monoxide.

3. The device according to claim 2, where the drying apparatus is arranged to dry ore concentrate by the heat energy obtained from burning carbon monoxide rich off-gas from a smelting furnace.

4. The device according to claim 3, where the drying apparatus comprises
a burning chamber comprising a burner arranged to burn carbon monoxide and/or carbon monoxide rich off-gas to produce hot gases, and
a drying chamber arranged to dry ore concentrate with said hot gases.

5. The device according to claim 4, where the grinder comprises a grinding chamber arranged to grind the ore concentrate during conveyance the ore concentrate through the grinding chamber; and where the grinding chamber and the drying chamber are built together, so that hot gases from a separate burning chamber are led to the grinding chamber.

6. The device according to claim 4, where the burning chamber, the drying chamber and the grinding chamber are built together so that the burner producing hot gases is attached directly to the grinder.

7. The device according to claim 1, where the drying apparatus comprises
a burning chamber comprising a burner arranged to burn carbon monoxide and/or carbon monoxide rich off-gas to produce hot gases, and
a drying chamber arranged to dry ore concentrate with said hot gases.

8. The device according to claim 7, where the grinder comprises a grinding chamber arranged to grind the ore concentrate during conveyance the ore concentrate through the grinding chamber; and where the grinding chamber and the drying chamber are built together, so that hot gases from a separate burning chamber are led to the grinding chamber.

9. The device according to claim 7, where the burning chamber, the drying chamber and the grinding chamber are built together so that the burner producing hot gases is attached directly to the grinder.
